(19) United States
(12) Patent Application Publication
(10) Pub. No.: US 2024/0319396 A1
(43) Pub. Date: Sep. 26, 2024

(54) GENERAL MACHINE LEARNING FRAMEWORK FOR PERFORMING MULTIPLE SEISMIC INTERPRETATION TASKS

(71) Applicant: Saudi Arabian Oil Company, Dhahran (SA)

(72) Inventors: Bingbing Sun, Dhahran (SA); Nasher Muqbel AlBinHassan, Dhahran (SA)

(73) Assignee: Saudi Arabian Oil Company, Dhahran (SA)

(21) Appl. No.: 18/188,954

(22) Filed: Mar. 23, 2023

(51) Int. Cl. G01V 1/50; E21B 44/00; G01V 1/46

(52) U.S. Cl. CPC G01V 1/50; E21B 44/00; G01V 2210/6169

(57) ABSTRACT

Methods and systems for performing simultaneous seismic interpretation are disclosed. The methods include obtaining a first seismic dataset pertaining to a first subterranean region of interest; and training a machine learning network to perform simultaneous seismic interpretation using the first seismic dataset, where simultaneous seismic interpretation includes completing a plurality of seismic interpretation tasks. The methods further include obtaining a second seismic dataset pertaining to a second subterranean region of interest and determining a simultaneous seismic interpretation of the second seismic dataset by performing simultaneous seismic interpretation using the trained machine learning network.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series of samples recorded at many receiver locations generated by a seismic source at many source locations constitutes a seismic dataset.

To determine the earth structure, including the presence of hydrocarbons, the seismic dataset may be processed. Processing a seismic dataset includes a sequence of steps designed to correct for a number of issues, such as near-surface effects, noise, and irregularities in the seismic survey geometry, etc. In another step in processing a seismic dataset a seismic velocity model may be determined representing the speed at which seismic waves propagate at various points within subsurface. The seismic dataset and the seismic velocity model may be combined using a process called “migration” to form a seismic image of the subsurface. Typically, such a seismic image displays points of high and low seismic reflection amplitude on a color scale or grayscale on a dense two-dimensional (2D) or three-dimensional (3D) grid of points representing the subsurface below the seismic survey area.

Although, the seismic image is influenced by the geological structures within the subsurface it does not directly identify what those structures are. For example, the seismic image may show a continuous band or surface of high amplitude reflection extending across the 3D grid of points and additional step is required to identify or label that band or surface as a geological boundary or interface separating different types of rocks (“geological formations”). Similarly, a discontinuity in the high amplitude reflection surface must be interpreted in the context of the rest of the seismic image and other information, such as well logging information, before it can confidently be identified or labelled as a geological fault or fracture. This step, of identifying the geological structures that are generating features in the seismic image is called seismic interpretation and is typically conducted using a seismic interpretation workstation. The result of seismic interpretation may be a 2D or 3D model of the geology within the subsurface. Such a model may typically be called a “geological model”.

While the steps of interpretation, such as identifying geological interfaces, locating faults, identifying pore fluid boundaries, and assigning geological classification (“facies”) to sub-volumes within the geological model may often be performed sequentially, the generation of a geological model is largely a wholistic task with each step, e.g., the identification of geological interfaces, affecting other tasks, e.g., the location (or “picking”) of faults. Thus, seismic interpretation is often a costly, time-consuming and iterative task whose outcome is subject to the subjective choices of the operator. Consequently, there is a clear and pressing need for an automated method and system capable of quickly, reliably and repeatably performing a wholistic seismic interpretation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Methods for performing simultaneous seismic interpretation are disclosed. The methods include obtaining a first seismic dataset pertaining to a first subterranean region of interest; and training a machine learning network to perform simultaneous seismic interpretation using the first seismic dataset, where simultaneous seismic interpretation includes completing a plurality of seismic interpretation tasks. The methods further include obtaining a second seismic dataset pertaining to a second subterranean region of interest and determining a simultaneous seismic interpretation of the second seismic dataset by performing simultaneous seismic interpretation using the trained machine learning network.

Systems for performing simultaneous seismic interpretation are disclosed. The systems include a seismic acquisition system, configured to obtain a first seismic dataset pertaining to a subterranean region of interest and obtain a second seismic dataset pertaining to a second subterranean region of interest; and a machine learning network. The machine learning network is configured to be trained to perform simultaneous seismic interpretation using the first seismic dataset, where simultaneous seismic interpretation includes completing a plurality of seismic interpretation tasks, and to determine a simultaneous seismic interpretation of the second seismic dataset once trained.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

FIG. 1 shows a flowchart in accordance with one or more embodiments

FIG. 2A depicts a seismic acquisition system in accordance with one or more embodiments.

FIG. 2B depicts a portion of a seismic dataset in accordance with one or more embodiments.

FIG. 2C shows a flowchart in accordance with one or more embodiments.

FIG. 3 show seismic images and geological models in accordance with one or more embodiments.

FIGS. 4A and 4B show flowcharts in accordance with one or more embodiments.

FIG. 5 illustrates a machine learning network in accordance with one or more embodiments.

FIGS. 6A-6C show components of bidirectional encoder representation from transformers in accordance with one or more embodiments.

FIG. 7 shows a machine learning network in accordance with one or more embodiments.

FIG. 8 shows a flowchart in accordance with one or more embodiments.

FIG. 9 depicts a drilling system in accordance with one or more embodiments.

FIG. 10 illustrates a block diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

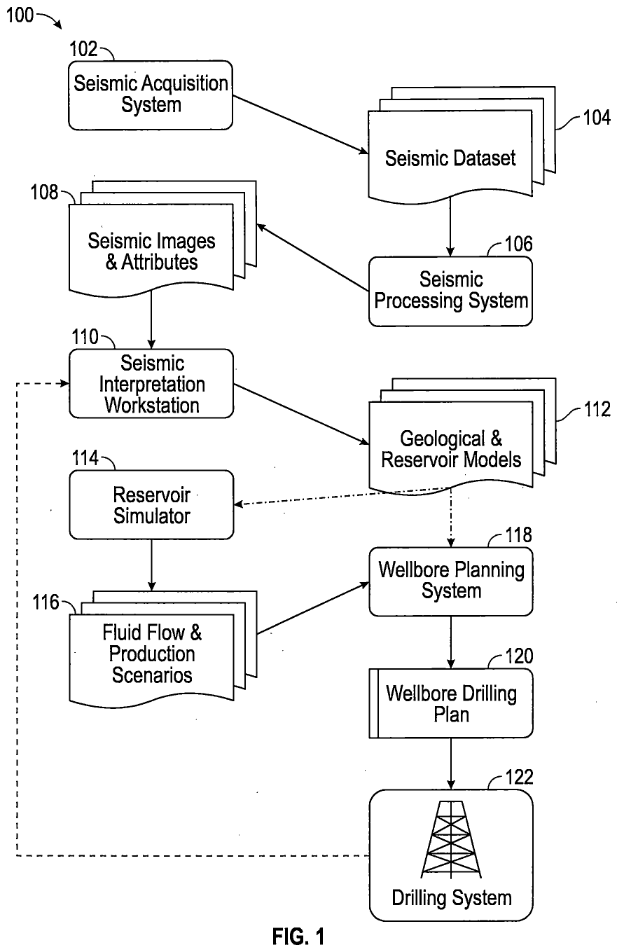

In the following description of FIGS. 1-10, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a geological boundary” includes reference to one or more of such geological boundaries.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Interpreting seismic images is an important step in the search for hydrocarbon reservoirs beneath the surface of the earth and in deciding how best to produce oil and gas from the reservoirs. Interpretation includes identifying the geological structures that are causing features visible in the seismic image may include building geological models, i.e., 2D or 3D representations of the subsurface geological structure. Such features may include, without limitation, boundaries between geological (rock) layers, faults and fractures, facies (i.e., rock type categories) and interfaces between pore fluids. Conventionally, different types of features are identified in sequential steps, e.g., boundaries between layers first, then faults, then facies. However, the conventional approach may require the use of multiple methods and, potentially, iterative loops where earlier steps are repeated, or inconsistent results. Consequently, the method of simultaneously and automatically interpreting multiple types of subsurface features, as disclosed herein, forms an improvement over the conventional methods.

FIG. 1 depicts a flowchart (100) in accordance with one or more embodiments. FIG. 1 illustrates the steps of acquiring remote sensing data, processing the remote sensing data, forming a geological model, optionally simulating the flow of fluids, including hydrocarbons, though the geological model, the planning of wellbores including their surface position, trajectories, and targets, and the drilling of those wellbores. Although the steps in flowchart (100) are shown in sequential order, it will be apparent to one of ordinary skill in the art, that some steps may be conducted in parallel, or in a different order than shown, or may be omitted without departing form the scope of the invention.

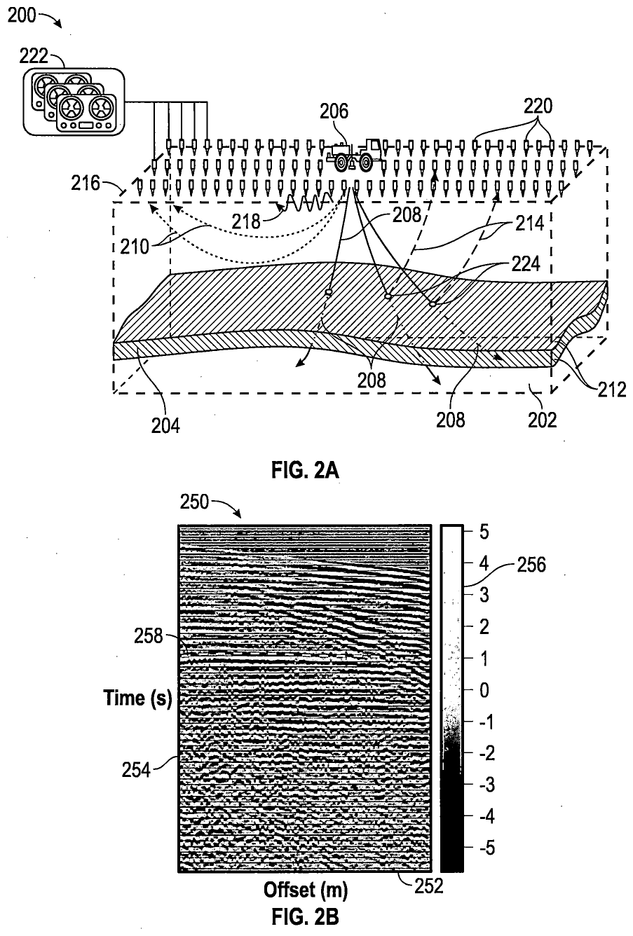

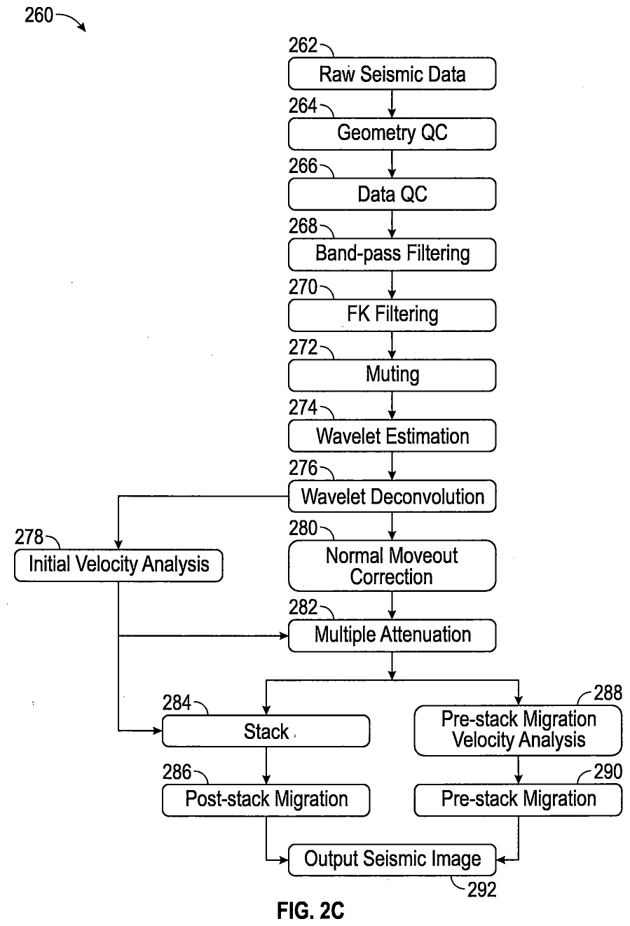

For example, flowchart (100) may begin with the use of a seismic acquisition system (102) to acquire a seismic dataset (104) over a subterranean region of interest. The seismic acquisition system (102) will be described in more detail in the context of FIG. 2A, and an example of a seismic dataset is shown in FIG. 2B. Other remote sensing datasets may also be collected at this stage to characterize the subterranean region of interest. For example, resistivity, transient electromagnetic, and/or gravitation surveys may be collected.

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors” in two-dimensional (“2D”) or three-dimensional (“3D”) space within the subterranean region. It will be appreciated by one of ordinary skill in the art that seismic datasets (104) are extremely large, typically occupying hundreds of Terabytes or more than a Petabyte in size and cannot be manipulated or “processed” without the assistance of a purpose—configured seismic processing system (106). A seismic processing system (106) may be composed of a computer system, such as the computer system shown in FIG. 11 configured with appropriate seismic processing software and augmented with a number of purpose specific elements, such as high capacity tape drives or hard drives connected through high-speed buses to computer processing units (“CPUs”). Further the CPUs of a seismic processing unit will typically be connected to a plurality of graphical processing units (“GPUs”) that perform may of the computational operations on the seismic dataset (104).

The result of processing a seismic dataset (104) with a seismic processing system (106) is a seismic image (108). The seismic image is a 2D or 3D image of the points within the subsurface that generate a distinctive seismic response. For example, the seismic image (108) may display the points at which seismic energy is reflected, or scattered, within the subsurface. Other seismic characteristic or “attributes” of the subsurface may be displayed as a seismic image (108). For example, the strength of conversion of energy from one type of seismic wave to another, or the strength of absorption of seismic energy, or the velocity of seismic propagation may be displayed as a function of subsurface position in the seismic image (108). The examples of seismic attributes given above are purely illustrative, and a person of ordinary skill in the art will appreciate that anyone of dozens of other attributes may be displayed as a seismic image (108) and the examples described should not be interpreted as limiting the scope of the invention in any way.

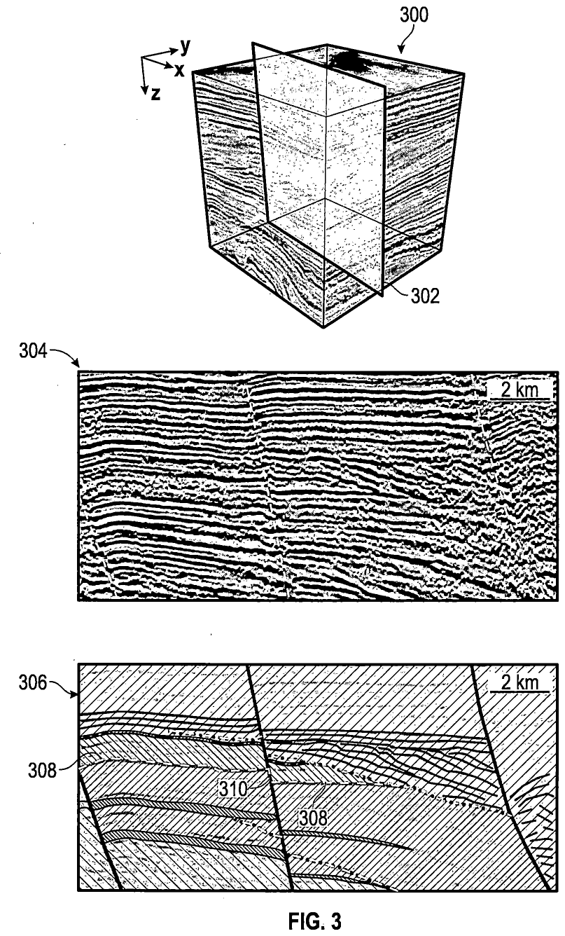

The seismic image (108) is an image, typically composed of pixels or varying intensity, and is not itself a model of the geological structure of the subterranean region to which it pertains. This distinction is illustrated below in FIGS. 3A-3D. To determine the geological structure corresponding to, or that produced, the seismic image (108) the seismic image (108) is typically “interpreted” using a seismic interpretation workstation (110). A seismic interpretation workstation (110) is typically composed of a computer system similar to the computer system (1100) shown in FIG. 11 and configured with seismic interpretation software and augmented with purpose specific peripherals such as high capability display devices that may include immersive or virtual reality devices, such as virtual-reality headsets or immersive “caves”, and enhanced means of interacting with the seismic image (108) such as a mouse, wand, or gesture-responsive sensors.

Additional data may be used within the seismic interpretation workstation (110) to facilitate the interpretation of the seismic dataset (104). Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

The result of interpreting the seismic image may be a geological model (112) of the subsurface, including reservoir models of hydrocarbon reservoirs within the subterranean region of interest. Geological models (112) may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system. Such a wellbore drilling plan (120) may contain drilling targets: geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system. Similarly, the wellbore drilling plan (120) may include a determination of wellbore caliper, and casing points.

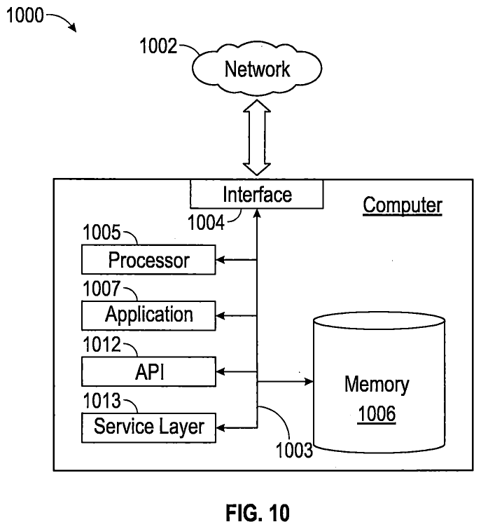

The wellbore planning system (118) may include dedicated software stored on a memory of a computer system, such as the computer system shown in FIG. 10. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

The wellbore path (904) may include a starting surface location of the wellbore, or a subsurface location within an existing wellbore, from which the wellbore (902) may be drilled. The wellbore path (904) may further include a terminal location that may intersect with the previously located hydrocarbon reservoir (204). The wellbore path (904) may further still include wellbore geometry information such as wellbore diameter and inclination angle and when each of these change along the depth of the wellbore. If casing is used, the wellbore plan (120) may include casing type or casing depths. Furthermore, the wellbore plan (120) may consider other engineering constraints such as the maximum wellbore curvature (“dog-log”) that a drillstring of a drilling system may tolerate and the maximum torque and drag values that the drilling system may tolerate. The wellbore plan (120) may further define associated drilling parameters, such as the planned depths at which casing will be inserted to support the wellbore (902) to prevent formation fluids entering the wellbore (902) and the drilling mud weights (densities) and types that may be used during drilling of the wellbore (902).

In other embodiments, the geological model (112) may be input to a reservoir simulator (114). A reservoir simulator (114) comprises functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into well penetrating the reservoir as a result of planned well drilling, and fluid injection and extraction. For example, the reservoir simulator may be used to predict fluid-flow and production scenarios (116) including changes in hydrocarbon production rate that would result from the injection of water into the reservoir from wells around the reservoirs periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected from well logs acquired in well penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators solve a set of mathematical governing equations that represent the physical laws that govern fluid flow in porous, permeable media. For example, the flow of a single-phase slightly compressible oil with a constant viscosity and compressibility the equations capture Darcy's law, the continuity condition and the equation of state.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The fluid flow and production scenarios (116) produced by the reservoir simulator (114) may then be used by the wellbore planning system (118) to determine the wellbore drilling plan (120).

FIG. 2A shows a seismic acquisition system (200) configured to acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region (202) and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receivers (220) may be positioned at a seismic receiver location that may be denoted (xᵣ, yᵣ) where x and y represent orthogonal axes, such as North-South and East-West, on the surface of the earth (216) above the subterranean region of interest (202). Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey. Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other case, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume, with coordinate axes (xᵣ, yᵣ, yₛ, yₛ, t).

FIG. 2B shows an illustrative example of a raw, i.e., unprocessed, seismic data display (250). The horizontal axis (252) indicates distance between the seismic source, such as seismic source (206) and the seismic receivers (220) recording each trace. The vertical axis (254) indicates recording time, increasing from the top to the bottom. The amplitude of each recorded sample is shown on the grayscale (256) with dark colors indicating negative amplitudes and light colors indicating positive amplitudes. The display is a composite of a plurality of traces running vertically with their horizontal location indicating the distance of the corresponding receiver from the seismic source. Reflections appear as quasi-continuous (“coherent”) curves traversing the display (250) such as the curve indicated with the dashed line (258).

To determine earth structure, including the presence of hydrocarbons, the seismic data set may be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Critical steps in processing seismic data include a seismic migration. Seismic migration is a process by which seismic events are re-located in either space or time to their true subsurface positions.

Seismic noise may be any unwanted recorded energy that is present in a seismic data set. Seismic noise may be random or coherent and its removal, or “denoising,” is desirable in order to improve the accuracy and resolution of the seismic image. For example, seismic noise may include, without limitation, swell, wind, traffic, seismic interference, mud roll, ground roll, and multiples. A properly processed seismic data set may aid in decisions as to if and where to drill for hydrocarbons.

FIG. 2C shows a simplified seismic processing flowchart (260) in accordance with one or more embodiments. Flowchart (260) begins with raw seismic data (262) such as that displayed in seismic data display (250). In step (264) quality control may be performed to identify and correct any errors in the seismic source (206) or seismic receivers (220) spatial location records. In step (266) quality control of the recorded seismic data may be performed. For example, receivers with anomalously high or low amplitudes may be identified based on comparison with spatially neighboring receivers. These anomalies may be indicative of malfunction seismic receivers (220) or poor coupling between the seismic receiver (220) and the surface of the earth (216). Anomalous amplitudes may be corrected (amplitude balancing) or set to zeroing (muting).

In step 268 the QC-ed data may be band-pass filtered to remove low signal to noise ratio (SNR) frequency bands. Band-pass filtering may include low-cut, high-cut, and notch-filtering. For example, in some geographical locations frequencies close to 60 Hz may be attenuated as they may be corrupted by electrical network noise. In step 270 the band-pass filtered data may be further frequency-wavenumber (fk) filtered to remove signals propagating across the array of seismic receivers (220) at a particular speed, or range of speeds. In particular, fk-filtering may be used to remove ground-roll energy (218). In step (272) some portions of the fk-filtered data may be muted. Specifically, individual trace or portions, such as large offsets or early time samples, that still exhibit poor SNR may be muted.

Typically, a seismic source emits a wavelet or pulse of seismic energy that has an oscillatory nature, while a seismic signal that is pulse like and compact in time is easier to process and interpret. Consequently, in step (274) the seismic wavelet may be estimated and in step (276) the wavelet may be deconvolved from the seismic data, resulting in seismic data that resembles that which would have been recorded if the seismic source (206) had emitted a short pulse. In step (278) an initial velocity analysis may be performed to determine an approximate velocity model. Such a velocity model describes the approximate speed of seismic wave propagation at points through the subterranean region of interest (202) and may be derived from the seismic data supplemented by wellbore measurements where available. Simultaneously, or in parallel, the seismic data may be normal moveout (NMO) corrected in step (280). NMO compensates the arrival time of reflections from a seismic reflector for the fact that reflections naturally arrive latter at seismic receivers with larger offsets. After NMO correction and initial velocity analysis, the seismic data may under-go multiple attenuation in step (282). Multiple attenuation removes or at least attenuates seismic energy that has been reflected downwards from the surface of the earth (216) one or more times or, in the case of internal multiple attenuation, has been downward reflected from seismic reflectors below the surface of the earth (216) at least once. Such seismic waves generally treated as noise by processing steps later in the flowchart and hence the removal of seismic multiples improves the SNR of the final processed seismic image.

After step (282) the processing workflow may split into two forks. For regions with simpler geological structures the first fork may be follow and the seismic data may be stacked in step (284) and then post-stack migrated in step (286) to produce an output seismic image (292). Stacking comprises adding, using a simple sum or sophisticated combination, seismic data time-samples determined to have undergone reflection from the same place in the subsurface. Post-stack migration corrects mispositioning of reflection events in the stacked image that occur due to variations in the seismic velocity model and large scale reflector dips.

In more complicated geological structures, the second fork may be followed. A refined velocity model may be determined from the seismic data using pre-stack migration velocity analysis in step (288). Crudely, pre-stack migration velocity analysis generates local seismic images of a range of velocity models at a plurality of coarsely sampled spatial locations and selects the velocity model that generates the most coherent (highest SNR) image as the correct seismic velocity model. Then, in step 290, the determined correct seismic velocity model is used to perform pre-stack migration on the entire seismic data.

Both post-stack migration and pre-stack migration may be performed in the time-domain or the depth-domain with the former being less computationally intensive but less accurate (particularly for complicated geological structures) than the latter.

A typical seismic dataset may be 100 Terabytes to 1 Petabyte in size, corresponding to between 10 trillion (10¹³) and 100 trillion (10¹⁴) data samples. Clearly, processing such a large volume of data manually, without the aid of computer system specifically configured to process seismic data, is completely unfeasible. Such a specially configured computer system may be termed a seismic processor, or seismic processing system. In addition to extensive arrays of tightly linked computer processing units (“CPUs”), a typical seismic processing system will include large arrays of graphical processing units (“GPUs”) to execute parallel processing, banks of high-speed tape, or hard-drive, readers to read the data from storage, high-speed tape or hard-drive writers to output final or intermediate results, and high-speed communication buses to connect these elements.

FIG. 3 shows an illustrative example of a processed seismic image (300). Processed seismic image (300) consists of a 3D grid of voxels, with each voxel representing a seismic attribute, such as a seismic reflection amplitude. The 3D grid of voxels forms a digital representation of a 3D portion of the subsurface. One or more 2D slices along planes, such as plane (302), may be taken through the 3D volume (300) and may be displayed as a 2D seismic slice (304). However, neither the 3D volume (300) nor the 2D slice (304) directly present geological structure, such as interfaces between geological formations, faults, pore fluid boundaries, delta fans, river channels, sandbars, or prehistoric reef structures. Geological features of this nature may be displayed in a geological slice (306) through a geological model, such as geological model (112). Geological slice (306) corresponds to the 2D seismic slice (306).

To identify geological structures and construct a geological model of this nature the seismic volume (300) must be interpreted, typically using a seismic interpretation workstation (110). Seismic interpretation may be performed using both manual and automated methods, individually or in combination. For example, in some cases, a geological formations boundary, such as geological boundary (308) may be identified in the 3D seismic volume (300) or the 2D seismic slice (304) manually by visually tracking (“picking”) and recording the trajectory of the seismic reflection manually associated with the geological boundary (308) across the 2D seismic slice (304) or through the 3D seismic volume (300). Alternatively, in other cases, the geological boundary (308) may be identified at a sparse number of “seed points” in the 3D seismic volume (300) or the 2D seismic slice (304) and the remainder of the geological boundary (308) may be picked automatically using any one of a number of methods known to one of ordinary skill in the art. In still other cases, the geological boundary (308) may be picked entirely automatically. Similarly, a person of ordinary skill in the art will be aware that a geological fault, such as geological fault (310), may be identified using similar manual and automatic procedures, operated individually or in combination.

The automated methods for interpreting 3D seismic volumes and 2D seismic slices known in the art, whether used to augment or replace manual methods, include methods based on machine learning (ML) networks. However, these ML network facilitated methods known in the art shares one common features: the ML network is trained to perform only one specific task, such as picking a geological boundary, or picking a geological fault, but not both simultaneously. As a result, such ML networks trained to pick a geological fault, cannot reliably pick a geological boundary, nor vice versa. This division of labor separating the picking of different categories of geological structure has two obvious disadvantages. Firstly, multiple ML networks must be created, trained, and maintained, at least on for each interpretation task. Second geological structures of different category are manifested in 3D seismic volumes and 2D seismic slices in a holistic manner with geological faults creating discontinuities in the manifestation of geological boundaries and geological boundaries terminating against prehistoric reef structures or salt domes. Consequently, identifying geological structures of different categories in a sequential rather than simultaneous manner, using multiple ML networks rather than a single ML network capable of interpreting geological structures from all categories, creates a significant danger that the resulting interpretation may be less accurate, and less robust than one obtained with a single multipurpose ML network.

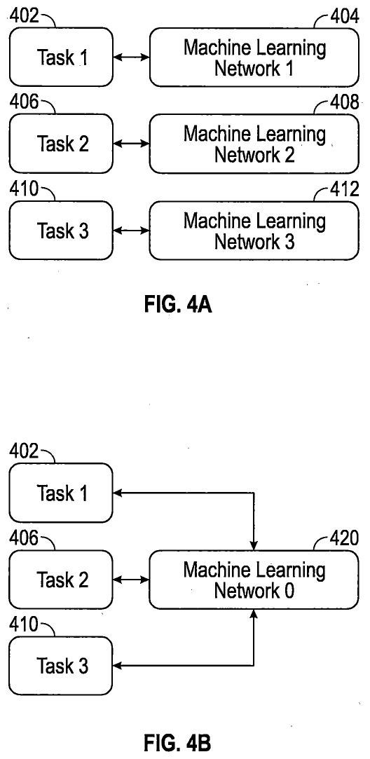

The distinction between prior art and the current invention may be illustrated by FIGS. 4A and 4B. In FIG. 4A, illustrating the prior art, there is a one-to-one mapping between a seismic interpretation task, such as Task 1 (402) and Machine Learning Network 1 (404). For example, Task 1 (402) may be the task of picking a geological boundary (308) from within the 3D seismic volume (300). Similarly, Task 2 (406) may be performed by Machine Learning Network 2 (408), and Task 3 (410) may be performed by Machine Learning Network 3 (412). For example, Task 2 (406) may be the task of picking geological faults (310) within the 3D seismic volume (300), and Task 3 (410) may be the task of identifying boundaries between pore fluids.

In contrast, FIG. 4B illustrates one or more embodiments of the current invention. In FIG. 4B a single ML network, such as Machine Learning Network 0 (420) may be trained to perform, and perform, multiple tasks. Although FIG. 4B depicts Machine Learning Network 0 (430) as being trained to perform, and performing, three tasks, Task 1 (402), Task 2 (406), and Task 3 (410), in some embodiments there may be only two tasks, while in other embodiments there may be four or more tasks, without departing from the scope of the invention.

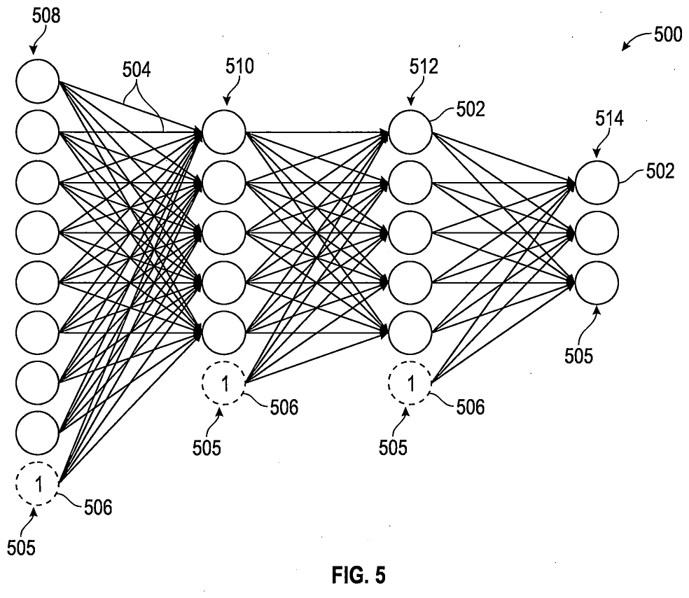

Turning now to FIG. 5, machine learning (ML), broadly defined, is the extraction of patterns and insights from data. The phrases “artificial intelligence,” “machine learning,” “deep learning,” and “pattern recognition” are often convoluted, interchanged, and used synonymously. This ambiguity arises because the field of “extracting patterns and insights from data” was developed simultaneously and disjointedly among a number of classical arts like mathematics, statistics, and computer science. For consistency, the term machine learning, or machine learned, will be adopted herein. However, one skilled in the art will recognize that the concepts and methods detailed hereafter are not limited by this choice of nomenclature.

In some embodiments, the ML network model may be a neural network (NN) or specifically a convolutional neural network (CNN). Thus, a cursory introduction to a NN and CNN is provided herein. However, note that many variations of an NN and a CNN exist. Therefore, one of ordinary skill in the art will recognize that any variation of an NN or a CNN (or any other ML model) may be employed without departing from the scope of this disclosure. Further, it is emphasized that the following discussions of an NN and CNN are basic summaries and should not be considered limiting.

A diagram of an NN is shown in FIG. 5. At a high level, an NN (500) may be graphically depicted as being composed of nodes (502) and edges (504). The nodes (502) may be grouped to form layers (505). FIG. 5 displays four layers (508), (510), (512), (514) of nodes (502) where the nodes (502) are grouped into columns. However, each group need not be as shown in FIG. 5. The edges (504) connect the nodes (502) to other nodes (502). Edges (504) may connect, or not connect, to any node(s) (502) regardless of which layer (505) the node(s) (502) is in. That is, the nodes (502) may be sparsely and residually connected. For example, in a recurrent neural network (RNN), nodes (502) in the output layer (514) may be connected by edges (504) to nodes (502) in the input layer (508) (though not shown in FIG. 5).

An NN (500) will have at least two layers (505), where the first layer (508) is the “input layer” and the last layer (514) is the “output layer.” Any intermediate layer (510), (512) is usually described as a “hidden layer.” An NN (500) may have zero or more hidden layers (510), (512). An NN (500) with at least one hidden layer (510), (512) may be described as a “deep” neural network or “deep learning method.” In general, an NN (500) may have more than one node (502) in the output layer (514). In these cases, the neural network (500) may be referred to as a “multi-target” or “multi-output” network.

Nodes (502) and edges (504) carry associations. Namely, every edge (504) is associated with a numerical value. The edge numerical values, or even the edges (504) themselves, are often referred to as “weights” or “parameters.” While training an NN (500), a process that will be described below, numerical values are assigned to each edge (504). Additionally, every node (502) is associated with a numerical value and may also be associated with an activation function. Activation functions are not limited to any functional class, but traditionally follow the form:

$$A = {f ( {\sum }_{i ∈ ( i n comi ng )} [ {( node value )}_{i} ( edge value )}_{i} ] ) , \qquad Equation ( 1 )$$

where i is an index that spans the set of “incoming” nodes (502) and edges (504) and f is a user-defined function. Incoming nodes (502) are those that, when viewed as a graph (as in FIG. 5), have directed arrows that point to the node (502) where the numerical value is being computed. Some functions ƒ may include the linear function ƒ(x)=x, sigmoid function

$$f ( x ) = \frac{1}{1 + {e}^{- x}} ,$$

and rectified linear unit function ƒ(x)=max(0,x), however, many additional functions are commonly employed. Every node (502) in an NN (500) may have a different associated activation function. Often, as a shorthand, activation functions are described by the function ƒ by which it is composed. That is, an activation function composed of a linear function ƒ may simply be referred to as a linear activation function without undue ambiguity.

When the NN (500) receives an input, the input is propagated through the network according to the activation functions and incoming node values and edge values to compute a value for each node (502). That is, the numerical value for each node (502) may change for each received input while the edge values remain unchanged. Occasionally, nodes (502) are assigned fixed numerical values, such as the value of 1. These fixed nodes (506) are not affected by the input or altered according to edge values and activation functions. Fixed nodes (506) are often referred to as “biases” or “bias nodes” as displayed in FIG. 5 with a dashed circle.

In some implementations, the NN (500) may contain specialized layers (505), such as a normalization layer, pooling layer, or additional connection procedures, like concatenation. One skilled in the art will appreciate that these alterations do not exceed the scope of this disclosure.

The number of layers in an NN (500), choice of activation functions, inclusion of batch normalization layers, and regularization strength, among others, may be described as “hyperparameters” that are associated to the ML model. It is noted that in the context of ML, the regularization of a ML model refers to a penalty applied to the loss function of the ML model. The selection of hyperparameters associated to a ML model is commonly referred to as selecting the ML model “architecture.”

Once a ML model, such as an NN (500), and associated hyperparameters have been selected, the ML model may be trained. To do so, M training pairs may be provided to the NN (500), where M is an integer greater than or equal to one. The variable m maintains a count of the M training pairs. As such, m is an integer between 1 and M inclusive of 1 and M where m is the current training pair of interest. For example, if M=2, the two training pairs include a first training pair and a second training pair each of which may be generically denoted an mth training pair. In general, each of the M training pairs includes an input and an associated target output. Each associated target output represents the “ground truth,” or the otherwise desired output upon processing the input. During training, the NN (500) processes at least one input from an mth training pair in the form of an mth training geological data patch to produce at least one output. Each NN output is then compared to the associated target output from the mth training pair in the form of an mth training feature image patch.

Returning to the NN (500) in FIG. 5, the NN (500) may be trained by first assigning initial values to the edges (504). These values may be assigned randomly, according to a prescribed distribution, manually, or by some other assignment mechanism. Once edge values have been initialized, the NN (500) may act as a function such that it may receive an input from an mth training pair and produce an output. At least one input is propagated through the neural network (500) to produce an output. The M training pairs will be discussed in more detail below.

The comparison of the NN (500) output to the associated target output from the mth training pair is typically performed by a “loss function.” Other names for this comparison function include an “error function,” “misfit function,” and “cost function.” Many types of loss functions are available, such as the log-likelihood function. However, the general characteristic of a loss function is that the loss function provides a numerical evaluation of the similarity between the NN (500) output and the associated target output from the mth training pair. The loss function may also be constructed to impose additional constraints on the values assumed by the edges (504). For example, a penalty term, which may be physics-based, or a regularization term may be added. Generally, the goal of a training procedure is to alter the edge values to promote similarity between the NN output and associated target output for most, if not all, of the M training pairs. Thus, the loss function is used to guide changes made to the edge values. This process is typically referred to as “backpropagation.”

While a full review of the backpropagation process exceeds the scope of this disclosure, a brief summary is provided. Backpropagation consists of computing the gradient of the loss function over the edge values. The gradient indicates the direction of change in the edge values that results in the greatest change to the loss function. Because the gradient is local to the current edge values, the edge values are typically updated by a “step” in the direction indicated by the gradient. The step size is often referred to as the “learning rate” and need not remain fixed during the training process. Additionally, the step size and direction may be informed by previous edge values or previously computed gradients. Such methods for determining the step direction are usually referred to as “momentum” based methods.

Once the edge values of the NN (500) have been updated through the backpropagation process, the NN (500) will likely produce different outputs than it did previously. Thus, the procedure of propagating at least one input from an mth training pair through the NN (500), comparing the NN output with the associated target output from the mth training pair with a loss function, computing the gradient of the loss function with respect to the edge values, and updating the edge values with a step guided by the gradient is repeated until a termination criterion is reached. Common termination criteria include, but are not limited to, reaching a fixed number of edge updates (otherwise known as an iteration counter), reaching a diminishing learning rate, noting no appreciable change in the loss function between iterations, or reaching a specified performance metric as evaluated on the m training pairs or separate hold-out training pairs (often denoted “validation data”). Once the termination criterion is satisfied, the edge values are no longer altered and the neural network 500 is said to be “trained.”

Turning to a CNN, a CNN is similar to an NN (500) in that it can technically be graphically represented by a series of edges (504) and nodes (502) grouped to form layers (505). However, it is more informative to view a CNN as structural groupings of weights. Here, the term “structural” indicates that the weights within a group have a relationship, often a spatial relationship. CNNs are widely applied when the input also has a relationship. For example, the pixels of a seismic image, such as seismic image (300), have a spatial relationship where the value associated to each pixel is spatially dependent on the value of other pixels of the seismic image. Consequently, a CNN is an intuitive choice for processing geological data 415 that includes a seismic image and may include other spatially dependent data.

A structural grouping of weights is herein referred to as a “filter” or “convolution kernel.” The number of weights in a filter is typically much less than the number of inputs, where now each input may refer to a pixel in an image. For example, a filter may take the form of a square matrix, such as a 3×3 or 7×7 matrix. In a CNN, each filter can be thought of as “sliding” over, or convolving with, all or a portion of the inputs to form an intermediate output or intermediate representation of the inputs which possess a relationship. The portion of the inputs convolved with the filter may be referred to as a “receptive field.” Like the NN (500), the intermediate outputs are often further processed with an activation function. Many filters of different sizes may be applied to the inputs to form many intermediate representations. Additional filters may be formed to operate on the intermediate representations creating more intermediate representations. This process may be referred to as a “convolutional layer” within the CNN. Multiple convolutional layers may exist within a CNN as prescribed by a user.

There is a “final” group of intermediate representations, wherein no filters act on these intermediate representations. In some instances, the relationship of the final intermediate representations is ablated, which is a process known as “flattening.” The flattened representation may be passed to an NN (500) to produce a final output. Note that, in this context, the NN (500) is considered part of the CNN.

Like an NN (500), a CNN is trained. The filter weights and the edge values of the internal NN (500), if present, are initialized and then determined using the M training pairs and backpropagation as previously described.

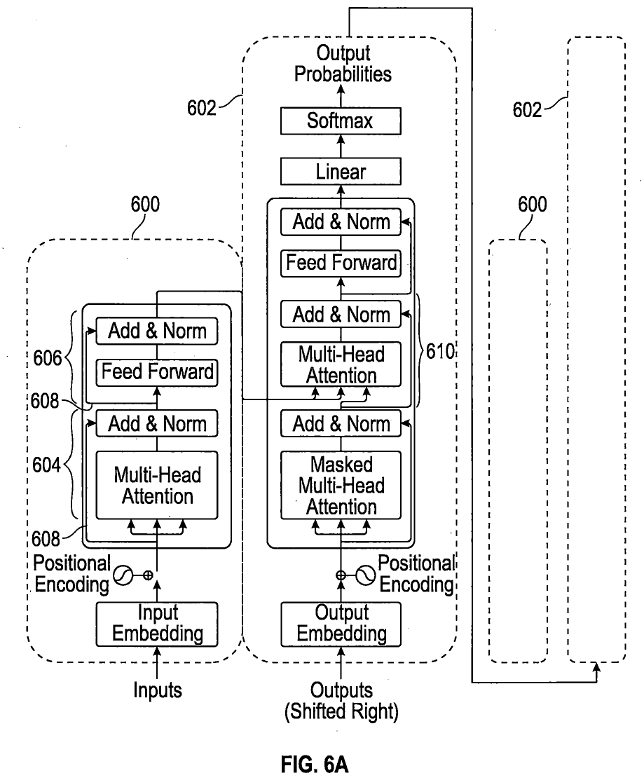

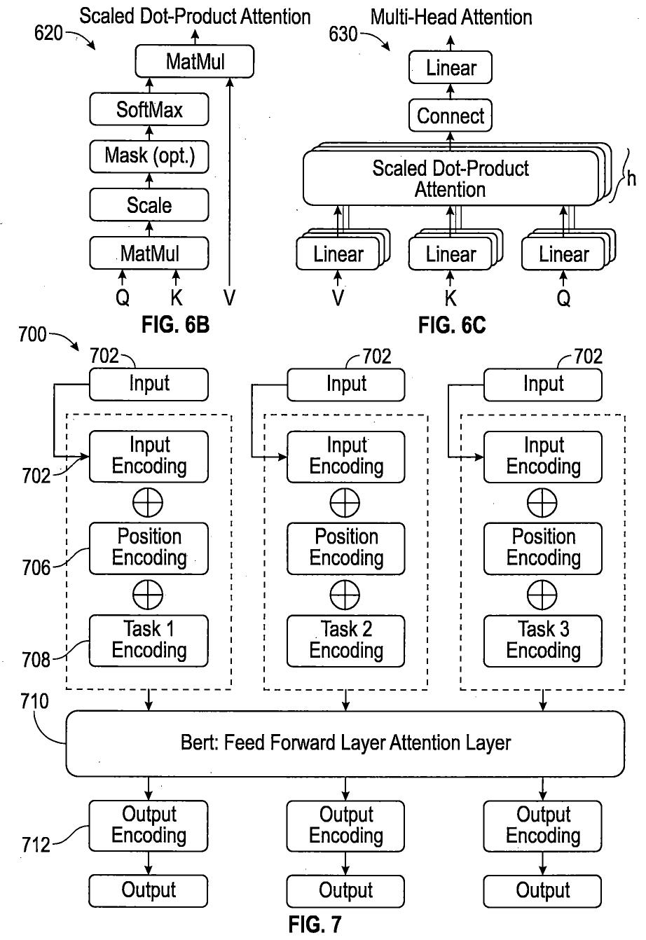

In accordance with one or more embodiments, the neural network architecture may be a modified BERT (Bidirectional Encoder Representation from Transformers) architecture. FIG. 6A shows a BERT architecture available in the art, without modification. In an encoder-decoder structure, the encoder (600) maps an input sequence of symbol representations to a sequence of continuous representations, z=(z₁, . . . , zₙ). Given z, the decoder (602) then generates an output sequence (y₁, . . . , yₘ) of symbols one element at a time. Note, M may, or may not, equal N. At each step the model is auto-regressive consuming the previously generated symbols as additional input when generating the next output. The transformer follows this overall architecture using stacked self-attention and point-wise, fully connected layers for both the encoder (600) and decoder (602), shown in the left and right halves of FIG. 6A, respectively.

The encoder (600) is composed of a stack of N=6 identical layers. Each layer has two sub-layers (604) and (606). The first layer (604) is a multi-head self-attention mechanism, and the second layer (606) is a simple, position-wise fully connected feed-forward network. A residual connection (608) may be disposed around each of the two sub-layers, followed by layer normalization. That is, the output of each sub-layer is LayerNorm(x+Sublayer(x)), where Sublayer(x) is the function implemented by the sub-layer itself. To facilitate these residual connections, all sub-layers in the model, as well as the embedding layers, produce outputs of a fixed dimension, e.g., dmodel=512.

The decoder (602) is also composed of a stack of N=6 identical layers. In addition to the two sub-layers in each encoder (600) layer, the decoder inserts a third sub-layer (610), which performs multi-head attention over the output of the encoder (600). Similar to the encoder (600), residual connections are disposed around each of the sub-layers, followed by layer normalization. The self-attention sub-layer (610) in the decoder stack is modified to prevent positions from attending to subsequent positions. This masking, combined with fact that the output embeddings are offset by one position, ensures that the predictions for position i can depend only on the known outputs at positions less than i.

An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

For example, attention functions may be “scaled dot-product attention” function (620) as shown in FIG. 6B. The input consists of queries and keys of dimension dₖ, and values of dimension dᵥ. The dot products of the query with all keys may be computed, divide each by values. dₖ, and apply a softmax function to obtain the weights on the values.

In practice, the attention function may be computed on a set of queries simultaneously, packed together into a matrix Q. The keys and values may also be packed together into matrices K and V. The matrix of outputs may be computed as:

$$A = Atte ntion ( Q , K , V ) = s o f t m a x ( \frac{Q {K}^{T}}{\sqrt{{d}_{m o d e l}}} ) V \qquad Equation ( 2 )$$

It may be understood that the attention layer tries to find the relation between different embeddings by cross-correlation between the query Q and the key K and the output is a weighted sum of the value V.

The two most commonly used attention functions are additive attention, and dot-product (multiplicative) attention. The dot-product attention is as described above, except for the scaling factor of 1/\sqrt{dₖ}. Additive attention computes the compatibility function using a feed-forward network with a single hidden layer. While the two are similar in theoretical complexity, dot-product attention is much faster and more space-efficient in practice, since it can be implemented using highly optimized matrix multiplication code. While for small values of dₖ the two mechanisms perform similarly, additive attention may outperform dot product attention without scaling for larger values of dₖ. To counteract this effect, dot products may be scaled by 1/\sqrt{dₖ}.

Instead of performing a single attention function with d_{model}-dimensional keys, values and queries, we found it beneficial to linearly project the queries, keys and values h times with different, learned linear projections to dₖ, dₖ and dᵥ dimensions, respectively. On each of these projected versions of queries, keys and values we then perform the attention function in parallel, yielding dᵥ-dimensional output values. These are concatenated and once again projected, resulting in the final values.

Multi-head attention (630) shown in FIG. 6C, allows the model to jointly attend to information from different representation subspaces at different positions. With a single attention head, averaging inhibits this.

$$MultiHead ( Q , K , V ) = Concat ( {head}_{1} , … , {head}_{h} ) {W}^{O} \qquad Equation ( 3 )$$

$$where$$

$${head}_{i} = Attention ( {QW}_{i}^{Q} , {KW}_{i}^{K} , {VW}_{i}^{V} ) \qquad Equation ( 4 )$$

and the projections are parameter matrices Wᵢ^{Q}∈ [symbol] ^{d}^{_{model}}^{×d}^{ₖ}, Wᵢ^{V}∈ [symbol] ^{d}^{_{model}}^{×d}^{ᵥ}, and Wᵢ^{Q}∈ [symbol] ^{hd}^{ᵥ}^{×d}^{_{model}}. For example, there may be h=8 parallel attention layers, or heads. For each of these dₖ=dᵥ=d_{model}/h=64 may be used. Due to the reduced dimension of each head, the total computational cost is similar to that of single-head attention with full dimensionality.

The transformer uses multi-head attention in three different ways. In “encoder-decoder attention” layers, the queries come from the previous decoder layer, and the memory keys and values come from the output of the encoder. This allows every position in the decoder to attend over all positions in the input sequence. This mimics the typical encoder-decoder attention mechanisms in sequence-to-sequence models.

The encoder contains self-attention layers. In a self-attention layer all of the keys, values and queries come from the same place, in this case, the output of the previous layer in the encoder. Each position in the encoder can attend to all positions in the previous layer of the encoder.

Similarly, self-attention layers in the decoder allow each position in the decoder to attend to all positions in the decoder up to and including that position. Leftward information flow in the decoder needs to be prevented to preserve the auto-regressive property. This may be implemented inside of scaled dot-product attention by masking out (setting to −∞) all values in the input of the softmax which correspond to illegal connections.

BERT networks are usually used to learn an embedded feature (embeddings) by pretraining. Then for different downstream tasks, different neural networks have to be trained again. In contrast the modified BERT network claimed herein need only be trained for a general neural network for performing multiple tasks simultaneous. Contrary to the original application of BERT, here the neural network is trained once only, without pretraining and downstream re-training. FIG. 7 illustrates the modified BERT network (700) in accordance with one or more embodiments.

The BERT network (700) is a sequence to sequence to model. Thus, the seismic interpretation dataset may first be transformed into the form of a sequence. For example, in the fault detection, horizon picking and facies classification problem, the input, as well as the output, may be considered as 3D volumes and thus a sequence may be formulated by forming cross-line, in-line section, or time(depth)-sections. That means, in some embodiments, the input blocks (702) receive a single (or multiples) cross-line section (in-line section or time(depth)-section). In other embodiments, ordered sub-volumes of the 3D seismic volumes may be selected as elements of the sequence. Such a sequence of length n may be denoted (d₁, d₁, . . . dₙ). In the encoding network (704), the input sequence may be encoded (or “embedded”) as:

The final input for further processing by the BERT (and we call it the embedding d′) would be:

$${d}_{i}^{′} = {E}_{1} ( {d}_{1} ) + {E}_{2} ( i ) + {E}_{3} ( t ) \qquad Equation ( 5 )$$

where i indexes input position, t indexes task. As shown in FIG. 7, E₁ is the input data encoding network (704), E₂ is the position encoding network (706), and E₃ is the task encoding network (708). In some embodiments, E₁, E₂, and E₃ may each be a neural network and will be trained simultaneously with E₁ learning features from the input data d₁, E₂ incorporating the position information for the input, and E₃ superposing the task information.

In other embodiments, the position encoding, E₂, may use Fourier transform instead of using a neural network. For example, a typical position encoding formula may be based on the sine and cosine encoding:

$${E}_{2} ( i ) = \{ \begin{matrix}sin ( \frac{i}{1000 {0}^{\frac{i}{{d}_{m o d e l}}}} ) if i is even \\ cos ( \frac{i}{1000 {0}^{\frac{i - 1}{{d}_{m o d e l}}}} ) ) if i is odd\end{matrix} \qquad Equation ( 6 )$$

where d_{model} denotes the vector size of the embedding d′.

The encoded data may be fed into the BERT network (710), consisting of a series of FeedForward and Attention modules described in FIG. 6. and will further extract and capture the features between the initial embeddings dᵢ′.

In accordance with one or more embodiments, the output of the BERT network (710) enters an output encoding layer (712), for output encoding, E₄, that may transform the internal embedding dᵢ′ into output, specific for each individual task:

$${q}_{i} = {E}_{4} ( {d}_{i}^{′} ) \qquad Equation ( 7 )$$

In some embodiments a loss-function may be used for training. For example, in some embodiments an L₂-norm loss-function may be used. In other embodiments a cross-entropy may be used. Specifically, if the true output, i.e., the label, is qᵢ⁰, a L₂-norm may be written as:

$$l ( {q}_{i} , {q}_{i}^{0} ) = {\sum }_{i} \frac{1}{2} {‖ {q}_{i} , - {q}_{i}^{0} ‖}^{2} \qquad Equation ( 8 )$$

Note that, a global loss-function may be defined as a sum over many tasks and positions:

$$L = {\sum }_{i} {\sum }_{L} l ( {q}_{i} , {q}_{i}^{0} ) \qquad Equation ( 9 )$$

Training the BERT network may further include finding the gradient:

$${Θ}_{n e w} = Θ + η \frac{\partial L}{\partial Θ} \qquad Equation ( 10 )$$

where η is the learning rate.

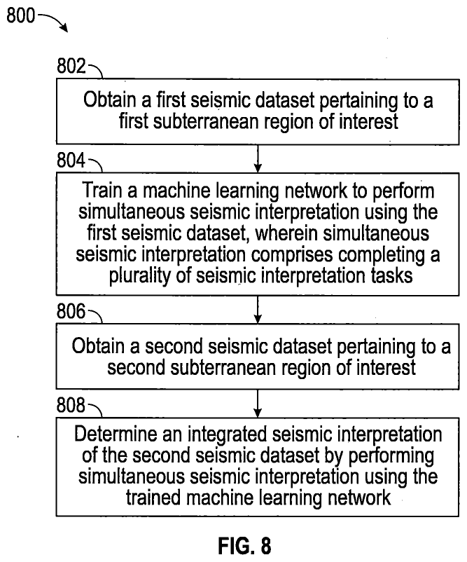

FIG. 8 shows a flowchart (800), in accordance with one or more embodiments. In Step 802, a first seismic dataset pertaining to a first subterranean region of interest may be obtained. In some embodiments, the first seismic dataset may be a migrated seismic image. Further, in some embodiments the migrated seismic image may be a migrated seismic image of a seismic attribute. The first seismic dataset may include dividing the first seismic dataset into a sequence made up of a plurality of cross-sections through the seismic image.

In Step 804 a machine learning network may be trained to perform simultaneous seismic interpretation using the first seismic dataset, wherein simultaneous seismic interpretation comprises completing a plurality of seismic interpretation tasks. The machine learning network may be a modified bidirectional encoder representation from transformers network.

Step 806 a second seismic dataset pertaining to a second subterranean region of interest may be obtained. In some embodiments, the second seismic dataset may be the first seismic dataset and/or the second subterranean region may be the first subterranean region.

Step 808 an integrated seismic interpretation of the second seismic dataset may be determined by performing simultaneous seismic interpretation using the trained machine learning network. Step 808 may further include identifying a drilling target in the second subterranean region based, at least in part, on the integrated seismic interpretation, and planning, using a well planning system, a planned wellbore trajectory to intersect the drilling target. Step 808 may still further include drilling, using a drilling system, a wellbore guided by the planned well trajectory.

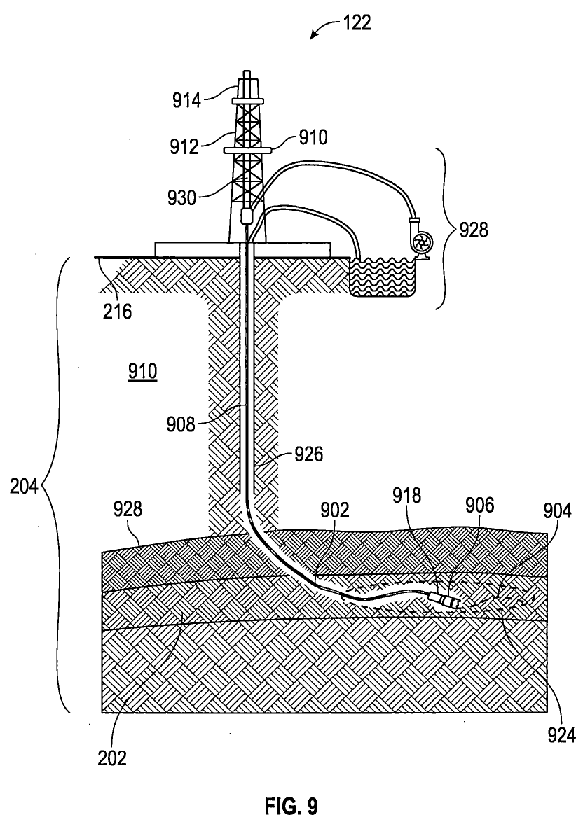

The planned wellbore trajectory contained in the wellbore drilling plan (120) may then be transferred to a drilling system (122) such that the wellbore path (904) may be drilled as illustrated in FIG. 9 in accordance with one or more embodiments. Although the drilling system (122) shown in FIG. 9 is used to drill a wellbore (902) on land, the drilling system (122) may also be a marine wellbore drilling system. The example of the drilling system (122) shown in FIG. 9 is not meant to limit the present disclosure.

As shown in FIG. 9, the wellbore (902) may be drilled using a drill rig that may be situated on a land drill site, an offshore platform, such as a jack-up rig, a semi-submersible rig, or a drill ship. The drill rig may be equipped with a hoisting system, such as a derrick (912), which can raise or lower the drillstring (908) and other tools required to drill the wellbore (902). The drillstring (908) may include one or more drill pipes connected to form conduit and a bottom hole assembly (BHA) (918) disposed at the distal end of the drillstring (908). The BHA (918) may include a drill bit (906) to cut into rock 1(910), including cap rock (928). The BHA (918) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (906), the weight-on-bit, and the torque. The LWD measurements may include sensors, such as resistivity, gamma ray, and neutron density sensors, to characterize the rock (910) surrounding the wellbore (902). Both MWD and LWD measurements may be transmitted to the surface of the earth (216) using any suitable telemetry system known in the art, such as a mud-pulse or by wired-drill pipe.

To start drilling, or “spudding in,” the wellbore (902), the hoisting system lowers the drillstring (908) suspended from the derrick (912) towards the planned surface location of the wellbore (902). An engine, such as a diesel engine, may be used to supply power to the top drive (914) to rotate the drillstring (908) via the drive shaft (930). The weight of the drillstring (908) combined with the rotational motion enables the drill bit (906) to bore the wellbore (902).

The near-surface of the subterranean region of interest (202) is typically made up of loose or soft sediment or rock, so large diameter casing (926) (e.g., “base pipe” or “conductor casing”) is often put in place while drilling to stabilize and isolate the wellbore (902). At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface of the earth (216).

Drilling may continue without any casing (926) once deeper or more compact rock is reached. While drilling, a drilling mud system (928) may pump drilling mud from a mud tank on the surface of the earth (216) through the drill pipe. Drilling mud serves various purposes, including pressure equalization, removal of rock cuttings, and drill bit cooling and lubrication.

At planned depth intervals, drilling may be paused and the drillstring (908) withdrawn from the wellbore (902). Sections of casing (926) may be connected and inserted and cemented into the wellbore (902). Casing string may be cemented in place by pumping cement and mud, separated by a “cementing plug,” from the surface of the earth (216) through the drill pipe. The cementing plug and drilling mud force the cement through the drill pipe and into the annular space between the casing (926) and the wall of the wellbore (902). Once the cement cures, drilling may recommence. The drilling process is often performed in several stages. Therefore, the drilling and casing cycle may be repeated more than once, depending on the depth of the wellbore (902) and the pressure on the walls of the wellbore (902) from surrounding rock (910).

Due to the high pressures experienced by deep wellbores (902), a blowout preventer (BOP) may be installed at the wellhead to protect the rig and environment from unplanned oil or gas releases. As the wellbore (902) becomes deeper, both successively smaller drill bits (906) and casing string may be used. Drilling deviated or horizontal wellbores (902) may require specialized drill bits (906) or BHA (918).

The drilling system (122) may be disposed at and communicate with other systems in the well environment. The drilling system (122) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target (924) within the hydrocarbon reservoir (204) is reached or the presence of hydrocarbons is established.

In some embodiments the wellbore planning system (118), the seismic processing system (106), and the seismic interpretation workstation (110) may each include a computer system.

FIG. 10 is a block diagram of a computer system (1000) used to provide computational functionalities associated with described algorithms, methods, functions, processes, flows, and procedures as described in the instant disclosure, according to an implementation. The illustrated computer (1000) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1000) may include a computer that includes an input device, such as a keypad, keyboard, touch screen, or other device that can accept user information, and an output device that conveys information associated with the operation of the computer (1000), including digital data, visual, or audio information (or a combination of information), or a GUI.

The computer (1000) can serve in a role as a client, network component, a server, a database or other persistency, or any other component (or a combination of roles) of a computer system for performing the subject matter described in the instant disclosure. The illustrated computer (1000) is communicably coupled with a network (1002). In some implementations, one or more components of the computer (1000) may be configured to operate within environments, including cloud-computing-based, local, global, or other environment (or a combination of environments).

At a high level, the computer (1000) is an electronic computing device operable to receive, transmit, process, store, or manage data and information associated with the described subject matter. According to some implementations, the computer (1000) may also include or be communicably coupled with an application server, e-mail server, web server, caching server, streaming data server, business intelligence (BI) server, or other server (or a combination of servers).

The computer (1000) can receive requests over network (1002) from a client application (for example, executing on another computer (1000)) and responding to the received requests by processing the said requests in an appropriate software application. In addition, requests may also be sent to the computer (1000) from internal users (for example, from a command console or by other appropriate access method), external or third-parties, other automated applications, as well as any other appropriate entities, individuals, systems, or computers.

Each of the components of the computer (1000) can communicate using a system bus (1003). In some implementations, any or all of the components of the computer (1000), both hardware or software (or a combination of hardware and software), may interface with each other or the interface (1004) (or a combination of both) over the system bus (1003) using an application programming interface (API) (1007) or a service layer (1008) (or a combination of the API (1007) and service layer (1008). The API (1007) may include specifications for routines, data structures, and object classes. The API (1007) may be either computer-language independent or dependent and refer to a complete interface, a single function, or even a set of APIs. The service layer (1008) provides software services to the computer (1000) or other components (whether or not illustrated) that are communicably coupled to the computer (1000). The functionality of the computer (1000) may be accessible for all service consumers using this service layer (1008). Software services, such as those provided by the service layer (1008), provide reusable, defined business functionalities through a defined interface. For example, the interface may be software written in JAVA, C++, or other suitable language providing data in extensible markup language (XML) format or other suitable format. While illustrated as an integrated component of the computer (1000), alternative implementations may illustrate the API (1007) or the service layer (1008) as stand-alone components in relation to other components of the computer (1000) or other components (whether or not illustrated) that are communicably coupled to the computer (1000). Moreover, any or all parts of the API (1007) or the service layer (1008) may be implemented as child or sub-modules of another software module, enterprise application, or hardware module without departing from the scope of this disclosure.

The computer (1000) includes an interface (1004). Although illustrated as a single interface (1004) in FIG. 10, two or more interfaces (1004) may be used according to particular needs, desires, or particular implementations of the computer (1000). The interface (1004) is used by the computer (1000) for communicating with other systems in a distributed environment that are connected to the network (1002). Generally, the interface (1004) includes logic encoded in software or hardware (or a combination of software and hardware) and operable to communicate with the network (1002). More specifically, the interface (1004) may include software supporting one or more communication protocols associated with communications such that the network (1002) or interface's hardware is operable to communicate physical signals within and outside of the illustrated computer (1000).

The computer (1000) includes at least one computer processor (1005). Although illustrated as a single computer processor (1005) in FIG. 10, two or more processors may be used according to particular needs, desires, or particular implementations of the computer (1000). Generally, the computer processor (1005) executes instructions and manipulates data to perform the operations of the computer (1000) and any algorithms, methods, functions, processes, flows, and procedures as described in the instant disclosure.

The computer (1000) also includes a memory (1009) that holds data for the computer (1000) or other components (or a combination of both) that may be connected to the network (1002). For example, memory (1009) may be a database storing data consistent with this disclosure. Although illustrated as a single memory (1009) in FIG. 10, two or more memories may be used according to particular needs, desires, or particular implementations of the computer (1000) and the described functionality. While memory (1009) is illustrated as an integral component of the computer (1000), in alternative implementations, memory (1009) may be external to the computer (1000).

The application (1006) is an algorithmic software engine providing functionality according to particular needs, desires, or particular implementations of the computer (1000), particularly with respect to functionality described in this disclosure. For example, application (1006) can serve as one or more components, modules, applications, etc. Further, although illustrated as a single application (1006), the application (1006) may be implemented as multiple applications (1006) on the computer (1000). In addition, although illustrated as integral to the computer (1000), in alternative implementations, the application (1006) may be external to the computer (1000).

There may be any number of computers (1000) associated with, or external to, a computer system containing computer (1000), each computer (1000) communicating over network (1002). Further, the term “client,” “user,” and other appropriate terminology may be used interchangeably as appropriate without departing from the scope of this disclosure. Moreover, this disclosure contemplates that many users may use one computer (1000), or that one user may use multiple computers (1000).

In some embodiments, the computer (1000) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A method, comprising:
obtaining a first seismic dataset pertaining to a first subterranean region of interest; and
training a machine learning network to perform simultaneous seismic interpretation using the first seismic dataset, wherein simultaneous seismic interpretation comprises completing a plurality of seismic interpretation tasks.

2. The method of claim 1, further comprising:
obtaining a second seismic dataset pertaining to a second subterranean region of interest; and
determining a simultaneous seismic interpretation of the second seismic dataset by performing simultaneous seismic interpretation using the trained machine learning network.

3. The method of claim 2, further comprising:
identifying a drilling target in the second subterranean region based, at least in part, on the simultaneous seismic interpretation; and
planning, using a well planning system, a planned wellbore trajectory to intersect the drilling target.

4. The method of claim 3, further comprising:
drilling, using a drilling system, a wellbore guided by the planned well trajectory.

5. The method of claim 2, wherein the second seismic dataset comprises the first seismic dataset and the second subterranean region comprises the first subterranean region.

6. The method of claim 1, wherein the first seismic dataset comprises a migrated seismic image.

7. The method of claim 6, wherein the migrated seismic image comprises a migrated seismic image of a seismic attribute.

8. The method of claim 7, wherein obtaining the first seismic dataset comprises dividing the first seismic dataset into a sequence comprising plurality of cross-sections through the migrated seismic image.

9. The method of claim 1, wherein the trained machine learning network comprises a modified bidirectional encoder representation from transformers network.

10. The method of claim 1, wherein training the machine learning network comprises forming a loss function.

11. The method of claim 6, wherein the plurality of seismic interpretation tasks comprises:
identifying a manifestation of a geological boundary between geological layers within the migrated seismic image; and
identifying a manifestation of a geological fault within the migrated seismic image.

12. A system for performing simultaneous seismic interpretation, comprising:
a seismic acquisition system, configured to obtain a first seismic dataset pertaining to a subterranean region of interest and obtain a second seismic dataset pertaining to a second subterranean region of interest; and
a machine learning network, configured to:
be trained to perform simultaneous seismic interpretation using the first seismic dataset, wherein simultaneous seismic interpretation comprises completing a plurality of seismic interpretation tasks, and
to determine a simultaneous seismic interpretation of the second seismic dataset once trained.

13. The system of claim 12, further comprising a well planning system, configured to plan a wellbore trajectory based, at least in part, on the simultaneous seismic interpretation.

14. The system of claim 13, further comprising a drilling system, configured to drilling a wellbore guided by the planned well trajectory.

15. The system of claim 12, wherein the second seismic dataset comprises the first seismic dataset and the second subterranean region comprises the first subterranean region.

16. The system of claim 12, further comprises a seismic processing system, configured to determine a first seismic volume from the first seismic dataset and a second seismic image form the second seismic dataset.

17. The system of claim 16, wherein the first seismic image is a first seismic attribute image, and the second seismic image is a second seismic attribute image.

18. The system of claim 16, wherein the seismic processing system is further configured to divide the first seismic dataset into a sequence comprising plurality of cross-sections through the seismic image.

19. The system of claim 12, wherein the trained machine learning network comprises a modified bidirectional encoder representation from transformers network.

20. The system of claim 12, wherein training the machine learning network comprises forming a loss function.
